(19) United States
(12) Patent Application Publication
(10) Pub. No.: US 2008/0259404 A1
(43) Pub. Date: Oct. 23, 2008

(54) IMAGE DISTRIBUTING APPARATUS AND IMAGE FORMING APPARATUS

(76) Inventor: Fumio Yoshizawa, Chiba (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/099,524

(22) Filed: Apr. 8, 2008

(30) Foreign Application Priority Data
Apr. 19, 2007 (JP) 2007-110290

(51) Int. Cl. G06K 15/00

(52) U.S. Cl. 358/3.28

(57) ABSTRACT

In an image distributing apparatus, an image file creating unit creates a first image file, and a reduced-size image creating unit creates a second image file, being smaller in size than the first image file. A link information adding unit adds identification information that uniquely identifies an external terminal to the second image file to obtain an identification information added image file. A medium writing unit writes the image file into a portable recoding medium. A controlling unit causes the medium writing unit to write the identification information added image file into the recording medium if the recording medium is connected to the medium writing unit, while the first image file is transmitted to the external terminal by a transmitting unit.

### CROSS-REFERENCE TO RELATED APPLICATIONS

The present application claims priority to and incorporates by reference the entire contents of Japanese priority document 2007-110290 filed in Japan on Apr. 19, 2007.

### BACKGROUND OF THE INVENTION

1. Field of the Invention

The present invention relates to a technology for scanning an image of an original or a photographed screen, converting the scanned image into image data to create an image file, and distributing the image file to other devices.

2. Description of the Related Art

Recently, with the aim of saving storage space, or sharing information with other, there is an increasing trend toward digitalizing of paper-based documents. Along with this trend, image reading apparatuses, such as document scanners, and applications for digitalizing paper-based documents have become widely used in many companies and even in ordinary households.

One of the applications for digitalizing paper-based documents using an image reading apparatus, such as a document scanner, includes a distribution scanner. A distribution scanner is used in the following manner. That is, a user places a paper-based document, which the user wants to digitalize, on an image reading apparatus, and specifies a destination for distributing a digitalized document (hereinafter, “digital document file”). The image reading apparatus acquires a digital document file by scanning the paper-based document and delivers the digital document file to the destination. The digital document file could be in a TIFF format, a PDF format, or some other format. Today, IP networks have become widely available in the world, and a digital document file can be distributed to any information processing terminals anywhere in the world, as long as the image reading apparatus can be connected to an IP network. Unlike known logistics such as a mailing system or a parcel delivery system, one does not need to be aware of the physical distance to the distributed destination.

As explained above, a distribution scanner is an excellent application that enables the user to deliver a digital document file to information processing terminals located anywhere in the world, by simply placing the paper-based document on the image reading apparatus and performing just few operations. The distribution scanner is also expected to be the most common method for digitizing the paper-based document in the years to come.

However, when using the distribution scanner, the user needs to perform a cumbersome operation to specify a destination for distributing the digital document file. Examples of the destination include a personal folder created in a network-attached storage (NAS) terminal, an e-mail box, or a desktop on a personal computer (PC). In any of these examples, the location of a destination is specified by a sequence of characters having a given length, such as an IP address, a folder name, or an e-mail address and it is cumbersome for the user to enter the sequence of characters without making any mistakes. Especially, because a small-sized image reading apparatus will have a small liquid crystal display and a few hardware keys as a user interface, an inexperienced user will find it difficult to enter a character sequence smoothly. Of course, the operation can be simplified by using a phone-book feature provided to the image reading apparatus to register destinations in advance, and call the registered destinations upon usage. However, this method is only effective for those who often use a specific image reading apparatus. No destinations are available in the phone book when a user is using an image reading apparatus for the first time or just happens to use the apparatus, thus the phone book cannot be a solution.

Because advanced technologies, such as high-speed scanners or broadband IP networks, have become available for scanning the paper-based documents, now a days shorter time is required for delivering digital document files to the destinations. However, to improve the productivity or convenience of the distribution scanner, it is necessary to reduce the time for preparations required before starting to scan the paper documents (such as time required for specifying the destinations). As long as the preparation requires time, a single user will occupy the image processing apparatus for a long time, preventing other users from using the apparatus, and the user will also experience inconvenience upon using the distribution scanner.

One approach could be to omit the task to specify the destination, which is one of the most cumbersome tasks in the preparation. In this approach, however, because the user starts scanning the paper-based document before specifying the destination, a digital document file will be stored in a temporary destination. Then, two types of information are written onto a recording medium that is detachable from the image processing apparatus, such as a secure digital (SD) card or a smart media, and the user receives the information. One of the information is, for example, a thumbnail image of the digital document file that allows the user to easily imagine the contents of the digital document file. The other information is, for example, a hyperlink that allows the user to easily identify where the digital document file is stored. On any information processing terminal, the user can then access the temporary destination to receive the desired digital document file.

In summary, the convenience improves because the user can use the distribution scanner with simple operations, as long as the user has a portable recording medium. Moreover, the image processing apparatus is occupied for less time, thus improving the productivity.

Some applications use a network document scanner to create therein an actual image file, which is an image data file scanned by the scanner, and a reduced image file, which is a file smaller in size than the actual image data file, and to provide these files to the user. Examples of these applications are disclosed in Japanese Patent Application Laid-open No. 2001-290695 and Japanese Patent Application Laid-open No. 2003-143359.

The Japanese Patent Application Laid-open No. 2001-290695 discloses an invention relating to an application that creates an actual image file from image information obtained by scanning a paper-based document, and stores the actual image file in the apparatus. The invention is characterized in that an HTML document is created and provided to the user. When the user requests a list of stored images, the HTML document indicates a path to the actual image file stored in the apparatus, and a reduced image thereof. The Japanese Patent Application Laid-open No. 2003-143359 discloses an invention relating to an application (distribution scanner) that creates an actual image file from the image information obtained by scanning the paper-based document, and distributes the actual image file to an external terminal. This invention is characterized in that, after the paper-based document is scanned, a plurality of reduced image files, each having a different image quality, is created and presented to the user to allow user to select one of the image qualities that the user prefers. Then, the actual image file is created in the selected image quality, and distributed.

In the file management system disclosed in the Japanese Patent Application Laid-open Number 2001-290695, a user cannot obtain link information and a reduced image unless the user actively makes some kind of action. Because originally, the main purpose of the invention is to create a list of actual image files, it is sufficient if the user instructs the image processing apparatus as required. In the distribution scanner disclosed in the Japanese Patent Application Laid-open No. 2003-143359, the user would makes fewer mistakes, because the user does not need to perform the entire operation all over again when the quality of the actual image file was not as intended or as preferred. Thus, the time for which a user occupies the distribution scanner can be reduced. However, the reduced image file is created only for the purpose to communicate to use how the resultant actual image file will be.

### SUMMARY OF THE INVENTION

It is an object of the present invention to at least partially solve the problems in the conventional technology.

According to an aspect of the present invention, there is provided an image distributing apparatus including an image reading unit that acquires image data by reading an image; an image file creating unit that creates a first image file from the image data; a transmitting unit configured to transmit the first image file to an external terminal over an IP network; a reduced-size image creating unit that creates a second image file, being smaller in size than the first image file, from the image data; a link information adding unit that adds identification information that uniquely identifies the external terminal to the second image file to obtain an identification information added image file; a medium writing unit that writes the image file into a portable recoding medium; and a controlling unit that causes the medium writing unit to write the identification information added image file into the recording medium if the recording medium is connected to the medium writing unit, while the first image file is transmitted to the external terminal by the transmitting unit.

According to another aspect of the present invention, there is provided an image forming apparatus including an image distributing apparatus including a document scanner that acquires image data by scanning a document; an image file creating unit that creates a first image file from the image data; a transmitting unit configured to transmit the first image file to an external terminal over an IP network; a reduced-size image creating unit that creates a second image file, being smaller in size than the first image file, from the image data; a link information adding unit that adds identification information that uniquely identifies the external terminal to the second image file to obtain an identification information added image file; a medium writing unit that writes the image file into a portable recoding medium; and a controlling unit that causes the medium writing unit to write the identification information added image file into the recording medium if the recording medium is connected to the medium writing unit, while the first image file is transmitted to the external terminal by the transmitting unit; a printer configured to print an image onto a printing medium; and an image data processing unit that converts the image data generated by the document scanner in the image distributing apparatus to printing image data suitable for printing by the printer, and outputs the printing image data to the printer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an image processing system according to a first embodiment of the present invention;

FIG. 2 is an enlarged plan view of an operation board shown in FIG. 1;

FIG. 3 is a block diagram of network connections established between terminals communicating over an IP network upon using a “distribution scanner” function of a multi-functional copy machine shown in FIG. 1;

FIG. 4 is an enlarged plan view of contents displayed on a liquid crystal touch panel shown in FIGS. 1 and 2, showing an input screen displayed thereon when the “distribution scanner” function is selected;

FIG. 5 is another enlarged plan view of contents displayed on the liquid crystal touch panel shown in FIGS. 1 and 2, showing an input screen displayed thereon when the “distribution scanner” function completes scanning an original image while a memory card is mounted to a media interface unit;

FIG. 6 is still another enlarged plan view of contents displayed on the liquid crystal touch panel shown in FIGS. 1 and 2, showing an input screen displayed thereon when the “distribution scanner” function completes scanning an original image while the memory card is not mounted to the media interface unit;

FIG. 7 is a block diagram of network connections established between the terminals communicating over the IP network and a flow of an image file when the “distribution scanner” function of the multi-functional copy machine shown in FIG. 1 is being used;

FIG. 8 is a plan view of an image stored in a first image file to be transferred from the multi-functional copy machine to an NAS server, shown in FIG. 1; and

FIG. 9 is a plan view of a thumbnail image in a second image file stored in the memory card shown in FIG. 1.

### DETAILED DESCRIPTION OF THE PREFERRED EMBODIMENTS

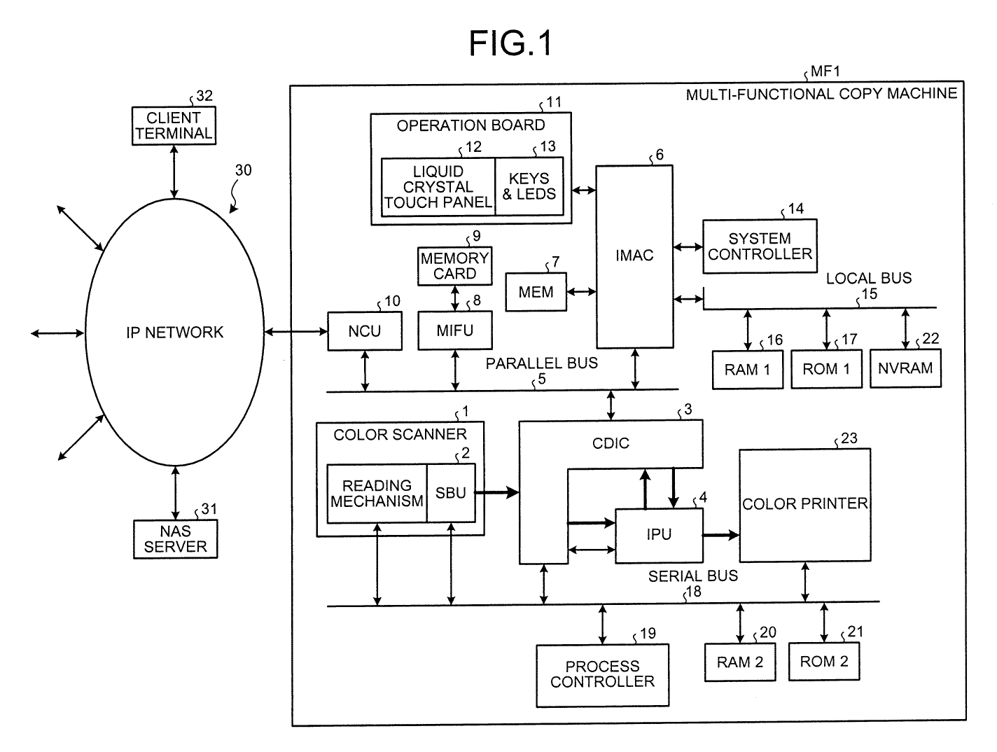

Exemplary embodiments of the present invention are described below with reference to the drawings. FIG. 1 is a block diagram of an image processing system according to a first embodiment of the present invention. This image processing system includes a multi-functional copying machine MF1 provided with an image distributing apparatus. In the multi-functional copying machine MF1, a color scanner 1 includes a sensor board unit (SBU) 2 and a reading mechanism that projects an original image onto a charge-coupled device (CCD) provided in the SBU 2. A light source in the reading mechanism irradiates the original with a light, and a light reflected on the original is projected onto the CCD through an optical lens. The CCD is an element for converting strength of a light into an analog electrical signal. The analog electrical signal output from the CCD is converted into image data (quantized data; digital data) by way of an A/D conversion, and output from the SBU 2.

A communication controller (CDIC) 3 is a unit that facilitates smooth transmission and reception (transfer) of image data among each of the units provided in the copy machine MF1. The SBU 2 and an image processing unit (IPU) 4 transmit and receive image data through the CDIC 3.

The IPU 4 is a unit that performs image processes to the digital image data received from the CDIC 3. The IPU 4 optimizes frequency or gradation characteristics of the image data, for example, depending on the characteristics of the copy machine MF1 itself or user requests. After being optimized, the digital image is transferred back to the CDIC 3. When the image is to be output (printed), the IPU 4 converts the image data into recording image data suitable for image representation characteristics of a color printer 23, and outputs the recording image data directly to the printer 23.

A memory controlling unit (IMAC) 6 is a unit that performs processes such as compression or expansion of the image data, and for reading or writing the image data (including the compressed data) from or to a memory (MEM) 7. The MEM 7 is a unit that stores therein the image data (including the compressed data).

A media interface unit (MIFU) 8 is a unit that reads and writes digital data from and to a portable recording medium (removable medium). Removable media of various standards are available, and a shape of a medium differs depending on the standard thereof. Therefore, the MIFU 8 has a plurality of slots, each corresponding to each of the shapes. The memory card 9, which is one of the portable recording media (removable media), is shown in FIG. 1. Data are recorded to a removable medium following a different scheme that depends on the standard thereof. Therefore, the MIFU 8 reads and writes the data following each of these standards. Especially in a “Memory to Media” operation, which will be described later, the MIFU 8 collects a thumbnail image, a hyperlink, and authentication information of a digital document file, and creates a thumbnail image file with link information.

A network controlling unit (NCU) 10 is a unit that establishes communications with other information processing terminals connected to an IP network. Upon transmitting data, the NCU 10 segments transmission data into packets according to a communication protocol of the IP network, and outputs the packets over the IP network. Upon receiving data, the NCU 10 reproduces original reception data that has been segmented into packets according to the communication protocol of the IP protocol. In “Memory to Network” operation, which will be described later, the NCU 10 operates to add the authentication function, such as a password, to image data, and to create a digital document file in a generally-available file format.

A liquid crystal touch panel 12, provided in an operation board 11, is a unit that displays information required when the user uses the copy machine MF1. The user can make various inputs and settings by touching soft keys displayed on the screen.

A process controller 19 controls operations of the scanner 1, the CDIC 3, the IPU 4, and the printer 23. The process controller 19 provides necessary settings to each of these units, and monitors startups, terminations, progress of processes of these units, and the like. A system controller 14 controls operations of the IMAC 6, the MEM 7, the NCU 10, the MIFU 8, and the liquid crystal touch panel 12 in the operation board 11. The system controller 14 provides necessary settings to each of these units, and monitors startups, terminations, and progress of processes of these units.

A random access memory (RAM) 16 and a read only memory (ROM) 17 connected to the IMAC 6 via a local bus 15 store therein information required for execution of processes by the system controller 14, the IMAC 6, the liquid crystal touch panel 12, the MEM 7, the NCU 10, and the MIFU 8. Example of stored information includes character information or bitmap information for displaying characters or pictures on the liquid crystal touch panel 12, a hyperlink-specified document to be added to a thumbnail image in the reduced image that is a second image file, a password-indicating document, or a total capacity or a remaining capacity that are available in the MEM 7. A non volatile ram (NVRAM) 22 stores therein an administrator's ID, a user ID, and a temporary destination (external terminal) for temporarily storing therein a digital document file (a first image file), each of which is registered in an initial setting. An example of the temporary destination is an IP address of an NAS server 31. In the first embodiment, an IP address and a hyperlink-specifying document are “external terminal identifying information”.

A RAM 20 and a ROM 21 connected to a serial bus 18 store therein information required for execution of processes by the scanner 1, the CDIC 3, the IPU 4 and the process controller 19. Examples of such information include a size of an original to be scanned by the scanner 1, optical characteristics of the CCD, or parameters for the image processes executed by the IPU 4.

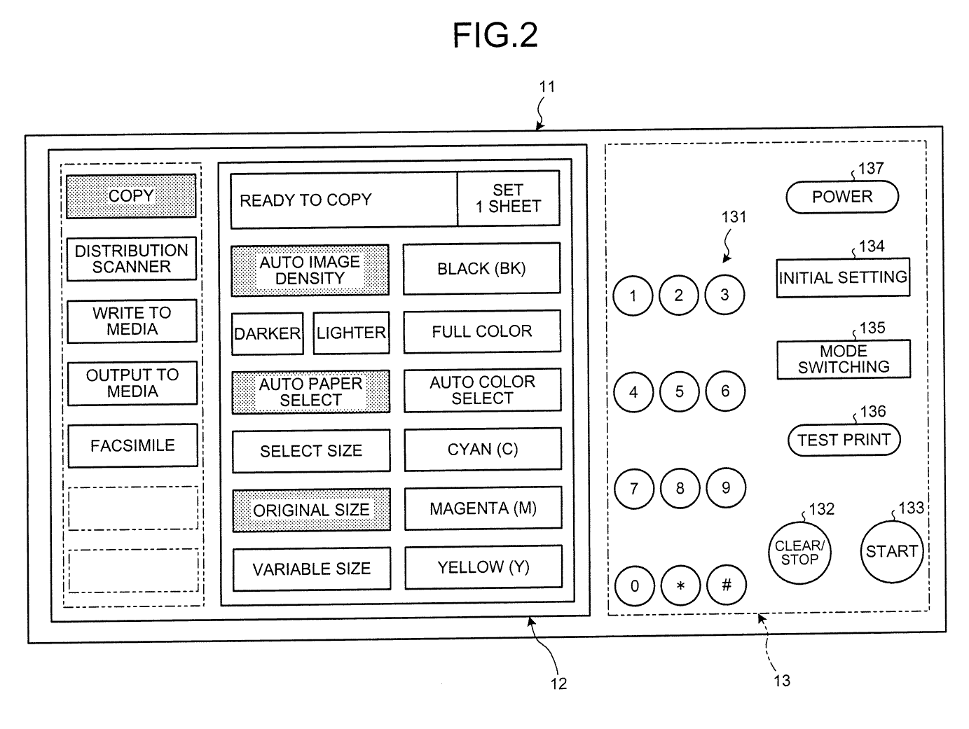

As shown in FIG. 2, in addition to the liquid crystal touch panel 12, the operation board 11 further includes a numeric key pad 131, a clear/stop key 132, a start key 133, an initial setting key 134, a mode switching key 135, a test print key 136, and a power key 137. During an inputting stage, where the user enters, sets, or registers a shortened version of a URL, a file name, or a folder name, alphabetical key buttons, with HIRAGANA appended, are displayed on the liquid crystal touch panel 12. The power key 137 is an operation key for instructing the apparatus to switch from a power saving mode (an idle mode or a low power consumption mode) to a standby mode where the image can be printed, and vise versa. If the power key 137 is pushed down for one time while the power saving mode is selected, the power saving mode is switched to the standby mode. If the power key 137 is pushed down for one time while the standby mode is selected, the standby mode is switched to the idle mode. The test print key 136 is a key for printing a single copy of a document, regardless of the number of copies specified, to allow the user to check the resultant printout.

The initial setting key 134 allows the user to customize the initial settings of the machine in a given manner. For example, the user can specify an expiration time for switching the machine into the power saving mode, sizes of papers stored in the machine, or conditions to return to when the reset key is pushed down for the copy function. In addition, the initial setting key 134 allows the user to register (write into the NVRAM 22) an address (an accessing address of the NAS server 31) linked from a hyperlink written into the memory card 9, which is one of the removable media, along with the thumbnail images in the “Memory to Media” operation, which will be described later. When the initial setting key 134 is operated, selection buttons are displayed so that the user can select from functions, such as an “initial value setting” function for setting various initial values, an “ID setting” function, an “NAS address setting” function, and a “usage history outputting” function. Upon selecting the “NAS address setting” function, the user can register (write into the NVRAM 22) the address (an IP address of the NAS server 31) linked from a hyperlink written into the memory card 9 along with the thumbnail images.

The liquid crystal touch panel 12 displays various function keys, input keys for users to enter conditions for performing the selected function, messages and the like. The liquid crystal touch panel 12 displays function selecting keys for selecting a function such as a “copy” function, a “distribution scanner” function, a “write-to-media” function, an “output-to-media” function, and a “facsimile” function, and progress thereof. If the user touches one of the function selecting keys, an input/output screen corresponding to the selected function is displayed on the liquid crystal touch panel 12.

For example, if the user selects the “copy” function, function keys corresponding thereto, a specified number of copies, and a message indicating the status of the image forming apparatus are displayed as shown in FIG. 2. The function keys include keys for specifying the printing colors, such as “black (BK)”, “full-color”, “automatic color selection”, “cyan (C)”, “magenta (M)”, and “yellow (Y)”. When an operator touches one of the keys displayed on the liquid crystal touch panel 12, the operation board 11 reads the operation as an operator input, and reversely displays the selected function key in gray to indicate that the function has been selected. Subsequently, the user can make a copy by setting an original on the scanner 1, and pressing down the start key.

If the user touches the selection key for the “distribution scanner”, the user can distribute an image, by scanning the original using the scanner 1, and transmitting the scanned image data to the NAS server 31, and accumulating the data therein. The “distribution scanner” function will be described later in detail.

The “write-to-media” function is a function to scan an original using the scanner 1, to generate an image file corresponding to the first image file, and to store the image in a removable medium (for example, the memory card 9).

The “output-to-media” function is a function that reads image data of an image file stored in the removable medium, causes the IPU 4 to convert the image data into a recording image data suitable for image formation performed by the printer 23, outputs the recording image data to the printer 23, and causes the printer 23 to form an image onto a printing paper based on the recording image data.

The “facsimile” function is a function to read an original using the scanner 1, and to transmit the read original via a facsimile.

The “distribution scanner” function will be now explained in detail. The “distribution scanner” function includes “Scan to Memory”, “Memory to Network”, and “Memory to Media” operations. If the user touches the “distribution scanner” button, shown in FIG. 2, displayed on the liquid crystal touch panel 12 of the operation board 11, the operation board 11 switches the screen displayed on the liquid crystal touch panel 12 to a scanning condition inputting screen shown in FIG. 4. If the user sets the scanning condition on this screen, and clicks on (touches) the “OK” button, an indicator on the start key 133 turns from red to green. When the user presses down the start key 133, the system controller 14 executes the “Scan to Memory” operation to scan the original using the scanner 1 and to write the image data into the MEM 7.

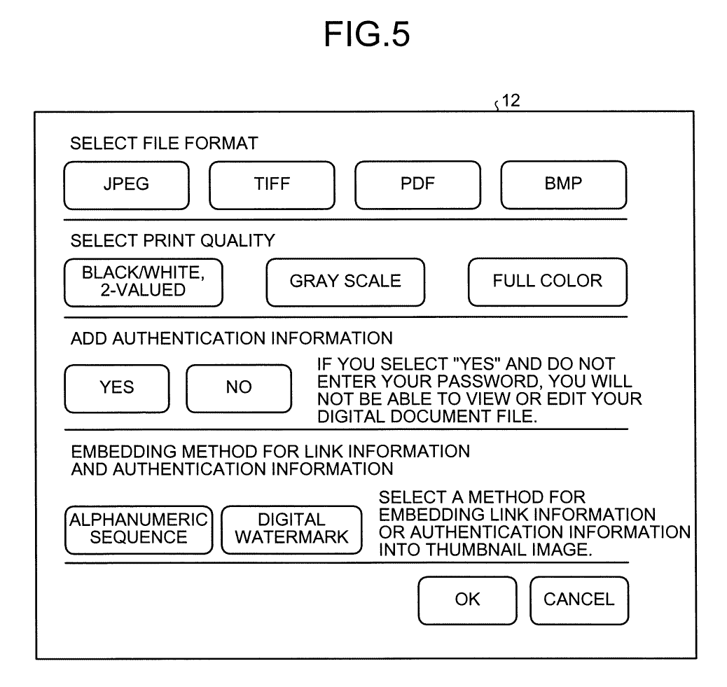

Upon completing scanning the original, the system controller 14 makes a reference to confirm if a removable medium, such as the memory card 9, is mounted to the MIFU 8. If a removable medium is mounted, a selecting screen shown in FIG. 5 is displayed on the liquid crystal touch panel 12. On this selecting screen, the user can select a data format for the first image file (the actual image file), an authentication setting, and an attaching method for attaching link information to the second image file (the reduced image file). If the user makes predetermined selections and clicks on the “OK” button, the system controller 14 executes the “Memory to Network”. Upon completing the transmission, the system controller 14 executes the “Memory to Media”.

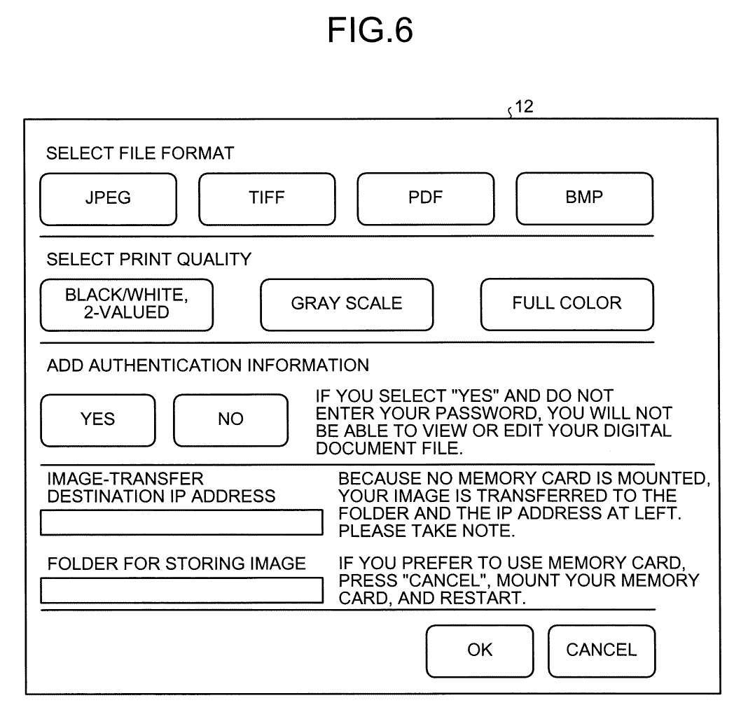

If no removable medium is mounted on the MIFU 8 upon completing scanning the original, the system controller 14 displays the selections of the data formats for the first image file (the actual image file), the authentication setting, and an IP address to transfer the image file (the IP address registered to the NVRAM 22; that is, the IP address of the NAS server 31), and an automatically-generated folder name on the liquid crystal touch panel 12, as shown in FIG. 6. The user needs to take a note of the IP address and the folder name. In the first embodiment, the folder name is a numeral code that is associated with an IP address and stored in the NVRAM 22. Every time the IP address is called, the numeral code is incremented by one, and used as a folder name for storing the first image file in the NAS server 31. If the user clicks on “OK”, the system controller 14 executes the “Memory to Network”. In this scenario, the “Memory to Media” is not executed.

The “Scan to Memory” is an operation to scan an original using the color scanner 1, and to accumulate the digital image in the MEM 7. The user places the original on a platen of the color scanner 1, and sets various scanning conditions via the liquid crystal touch panel 12 of the operation board 11 (see FIG. 4). When the “OK” button is pressed down, the conditions set by the user are transferred to the process controller 19 and the system controller 14. The process controller 19 stores the transferred scanning conditions to the RAM 20, and instructs the scanner 1, the CDIC 3, and the IPU 4 to operate according to the scanning conditions. The system controller 14 stores the transferred conditions to the RAM 16, and instructs the IMAC 6, the MEM 7, the NCU 10, and the MIFU 8 to operate according to the scanning conditions.

When the instructions to each of the units are completed, the scanner 1 scans the document on the platen, and transfers image data to the CDIC 3. The CDIC 3 forwards the image data, transferred from the SBU 2, to the IPU 4. The IPU 4 performs image processes to compensate for optical characteristics of the SBU 2. After the image processes have been completed, the image data is transferred to the CDIC 3. The CDIC 3 forwards the image data, transferred from the IPU 4, to the IMAC 6 via a parallel bus 5. The IMAC 6 converts the image data to a storing format that is storable in the MEM 7, and stores the converted image data in the MEM 7. During these operations, statuses of the color scanner 1, the IPU 4, and the CDIC 3 are sequentially notified to the process controller 19. Statuses of the IMAC 6 and the MEM 7 are sequentially notified to the system controller 14. Upon completion of storing the image data, the process controller 19 causes the operation board 11 to display the completion thereof, and ends the “Scan to Memory” operation.

The “Memory to Network” is an operation to create a digital document file, which is the first image file, from the image data accumulated in the MEM 7, and to transmit the digital document file to an “external terminal”, which is a temporary destination. In the first embodiment, the “external terminal” is the NAS server 31. The IP address of the NAS server 31, located in the IP network 30, is written into or registered to the NVRAM 22 in the initial setting that is initiated when the initial setting key 134 is operated on the operation board 11.

To begin with, the user provides settings, such as the file format of the digital document file, the image quality, or the authentication setting, through the operation board 11 (See FIG. 5). Upon the “OK” button being pressed, the user settings are transferred to the process controller 19 and the system controller 14. The process controller 19 stores the received user settings to the RAM 20, and instructs the CDIC 3 and the IPU 4 to operate according to the user settings. The system controller 14 stores the received user settings to the RAM 16, and instructs the IMAC 6, the MEM 7, and the NCU 10 to operate according to the user settings. When the process controller 19 and the system controller 14 complete giving instructions to each of the units, the IMAC 6 reads the image data from the MEM 7, and expands the image data into the original image format before being stored in the MEM 7. The IMAC 6 then transfers the digital image data to the CDIC 3 via the parallel bus 5. The CDIC 3 forwards the image data received from the IMAC 6 to the IPU 4. The IPU 4 performs image processes to optimize the frequency or gradation characteristics, or size (the number of pixels) of the image data so that the image data is optimized for the digital document file.

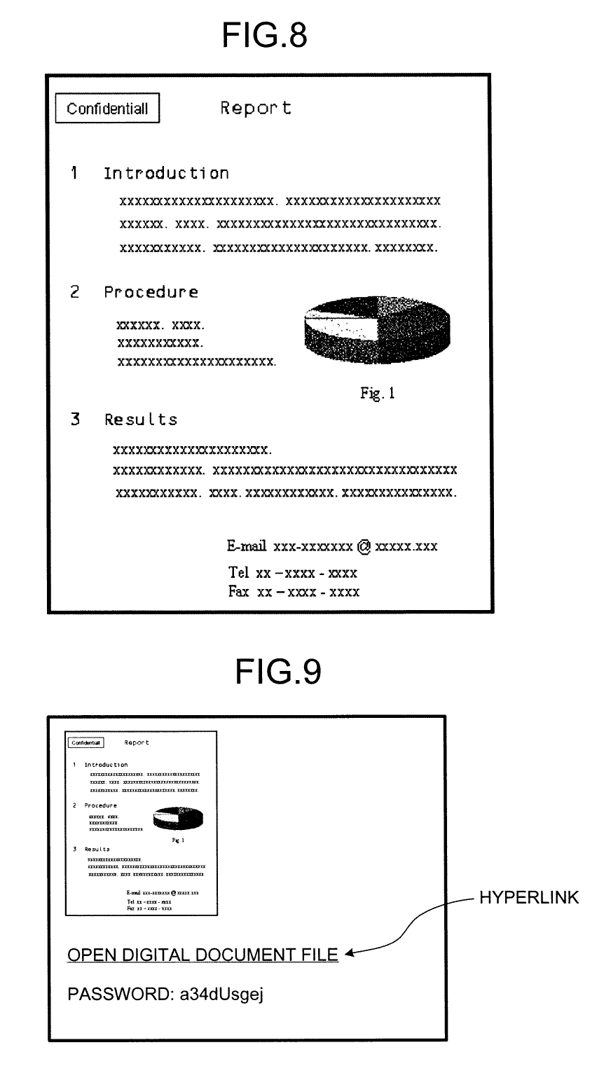

The image data that has been provided with the image processes in the IPU 4, is transferred back to the CDIC 3. The CDIC 3 forwards the image data received from the IPU 4 to the NCU 10 via the parallel bus 5. The NCU 10 adds authentication information, such as a password, to the image data received from the CDIC 3, and creates a digital document file in a common file format, such as TIFF, JPEG, or PDF format (See FIG. 8. However, when a security function is to be added, the file formats are limited to those that can support such addition of the security function.). The NCU 10 then transmits the digital document file (the first image file; the actual image file) to the temporary destination, the NAS server 31 (the external terminal). During these operations, the statuses of the IMAC 6, the MEM 7, and the NCU 10 are sequentially notified to the system controller 14. The statuses of the CDIC 3 and the IPU 4 are sequentially notified to the process controller 19. When the NCU 10 completes transmitting the digital document file, the system controller 14 causes the operation board 11 to display the completion thereof, and ends the “Memory to Network” operation.

The “Memory to Media” is an operation to create a thumbnail image file (the second image file), embedded with information for accessing the digital document file stored in the temporary destination, from the image data accumulated in the MEM 7 and to write the thumbnail image file into a removable medium, such as the memory card 9. To begin with, the user provides settings, such as a method for embedding the information for accessing the digital document file, through the operation board 11 (See FIG. 5). When the “OK” button is pressed down, the user settings are transferred to the process controller 19 and the system controller 14. The process controller 19 stores the received user settings to the RAM 20, and instructs the CDIC 3 and the IPU 4 to operate according to the user settings. The system controller 14 stores the received user settings to the RAM 16, and instructs the IMAC 6, the MEM 7, and the MIFU 8 to operate according to the user settings. When the process controller 19 and the system controller 14 complete giving instructions to each of the units, the IMAC 6 reads the image data from the MEM 7, expands the image data into the original image format before being stored in the MEM 7, and transfers the image data to the CDIC 3 via the parallel bus 5. The CDIC 3 forwards the image data received from the IMAC 6 to the IPU 4. The IPU 4 performs image processes to optimize the frequency, gradation characteristics, or a number of pixels of the image data so that the image data is optimized for a thumbnail image file with link information (the second image file; the reduced image file). The image data that are provided with the image processes in the IPU 4 is transferred back to the CDIC 3. The CDIC 3 forwards the image data received from the IPU 4 to the MIFU 8 via the parallel bus 5. The MIFU 8 embeds the link information, such as a hyperlink, and the authentication information, such as a password, into the image data received from the CDIC 3 visibly (See FIG. 9) or invisibly, by way of digital watermarking, for example, and creates an image file in a common file format, and writes the created image file to the removable medium.

During these operations, the statuses of the IMAC 6, the MEM 7, and the MIFU 8 are sequentially notified to the system controller 14. The statuses of the CDIC 3 and the IPU 4 are sequentially notified to the process controller 19. When the MIFU 8 completes writing the thumbnail image with the link information into the removable medium, the system controller 14 causes the liquid crystal touch panel 12 of the operation board 11 to display the completion thereof, and ends the “Memory to Media” operation.

The “Scan to Memory”, the “Memory to Network”, and “Memory to Media” operations do not necessarily have to be performed in the order described above. For example, if the IP network is congested, or a writing operation to the removable medium is slow, the “Scan to Memory” job can be performed in advance. In this manner, the original can be scanned at a stable speed regardless of congestion of the IP network or the performance of the removable medium. In addition, because some common file formats enable a plurality of scanned images to be stored as a single file (such as the PDF or the TIFF format), the “Scan to Memory” job might not be performed for the same number of times as the “Memory to Network” and the “Memory to Media” jobs. These jobs are managed by the system controller 14.

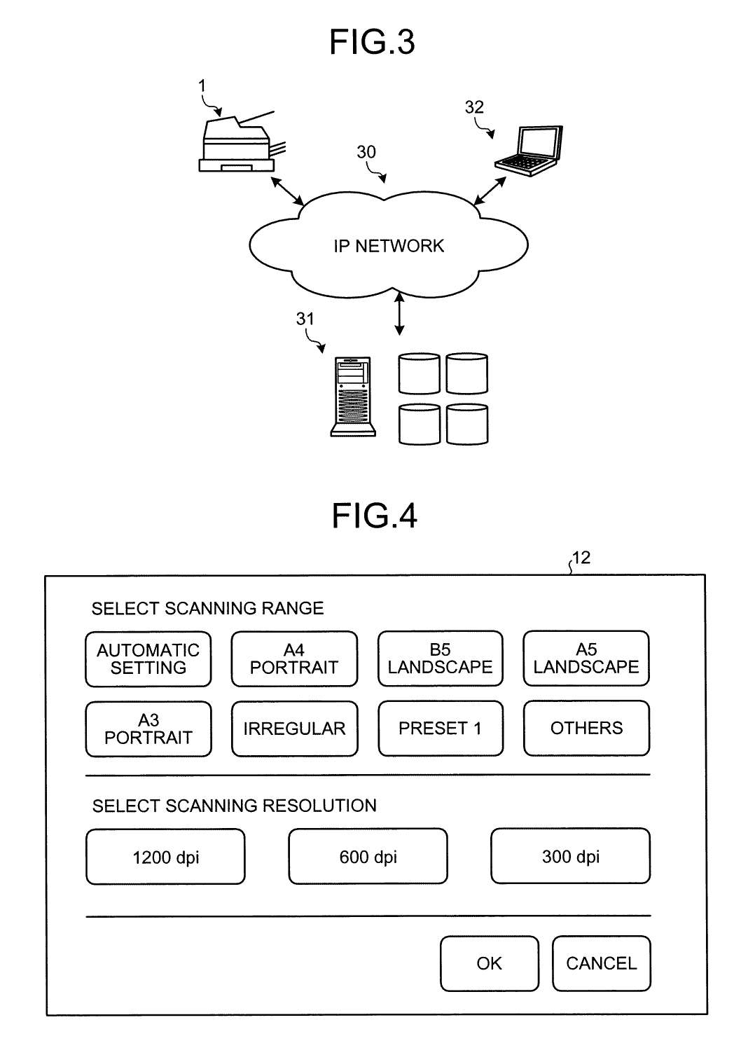

An exemplary operation performed by the “distribution scanner”, in which these basic operations above are combined, will be now explained. As shown in FIG. 3, the copy machine MF1 is connected to the NAS server 31 that is the temporary destination to distribute the digital document file, over the IP network. A client terminal owned by the user (the real destination that the user has in mind) can be connected to the IP network as required.

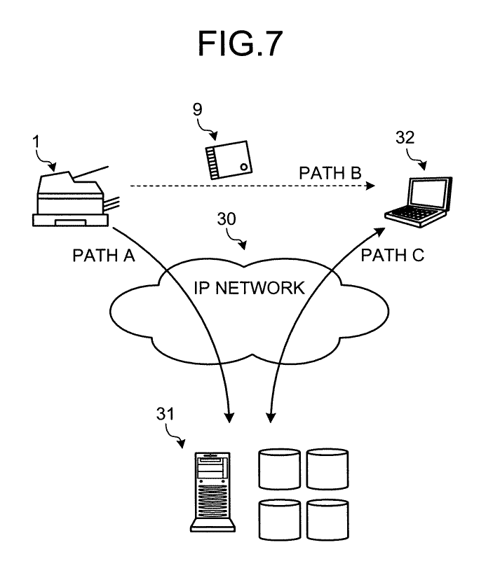

To begin with, the user inserts a removable medium, such as the memory card 9, into a dedicated slot on the MIFU 8. After placing an original the user wants to digitize on the color scanner 1, the user performs various settings, such as those explained above, through the operation board 11. When the user completes performing all settings, the “Scan to Memory” and the “Memory to Network” operations are sequentially performed. The scanned paper-based document is temporarily stored in the NAS server 31 (the external terminal) as a digital document file (the first image file) (over a path A shown in FIG. 7). Subsequently, the “Memory to Media” operation is performed, and a thumbnail image file with link information (the second image file) is written into the removable medium (portable recording medium).

It is only up to this point that the user occupies the copy machine MF1. Subsequently, the user brings back the memory card 9 (the removable medium) (over a path B shown in FIG. 7), and accesses the thumbnail image with link information from a user terminal, for example, a client terminal 32. As one of the examples, the thumbnail image file with link information includes a reduced image, which is sufficient to enable the user to imagine the contents of the digital document file, and a hyperlink embedded with the IP address of the NAS server 31 (the temporary destination), as shown in FIG. 9. If the user selects the part with statement “open digital document file” with an underline using a pointing device, such as a mouse, the client terminal 32 starts accessing to the digital document file linked to the hyperlink (over a path C shown in FIG. 7). If the client terminal 32 is not connected to the IP network, the connection is established at this point. When the user moves the digital document file from the NAS server 31 (the temporary destination) to the client terminal 32, the digital document file is delivered to its final destination.

Because the thumbnail image file (the second image file) is created in a common file format, the thumbnail image file can be reused. For example, after deciding the final location to store the digital document file in the client terminal 32, the user can edit the thumbnail file to change the hyperlink to the new destination (the client terminal 32). In this manner, if, for example, the user wishes to share the digital document file with another person, the user can simply send the thumbnail image file (the second image file), allowing the person to access to the digital document file.

The “distribution scanner” can be used by the unspecified number of people. Therefore, various digital document files can be stored in the NAS server 31, and there are risks that someone else could access, download, or edit your digital document file without your permission. To prevent such acts, according to the first embodiment, an authentication function is provided, in which the authentication information is added to the digital document file (the first image file). If such function information is added to the digital document file, the information required for authentication is provided visibly in the thumbnail image file, by way of alphanumerical sequence for example (a password in FIG. 9), or invisibly, by way of a digital watermark. As a result, only the user who has the thumbnail image (the second image file) can make operations to the digital document file (the first image file). Especially if the authentication information is embedded invisibly, for example, by way of a digital watermark, the authentication information can be advantageously protected, so that one cannot steal the authentication information easily by obtaining unauthorized access to the thumbnail image.

According to an aspect of the present invention, a user can display a second image file, which is a reduced image file, recorded in a portable medium on a user terminal, and can receive a first image file to the user terminal by accessing an external terminal based on external terminal identifying information displayed with the reduced image file. Because the user does not need to enter an address of the external terminal upon distribution, the user operation can be simplified upon being distributed with the image.

According to another aspect of the present invention, when the user displays the second image file, which is the reduced image file, recorded in the portable medium on the user terminal, the external terminal identifying information is a hyperlink. Therefore, the user can access the first image file located at the external terminal just by clicking on the hyperlink. Because the user does not need to enter the address of the external terminal, the user operation can be simplified upon obtaining the first image file.

According to still another aspect of the present invention, the user can be authenticated to the external terminal on the user terminal, using authentication information provided in the second image file, upon obtaining the first image file. Thus, only the owner of the second image file can obtain the first image file. Therefore, higher confidentiality can be achieved for the first image file.

According to still another aspect of the present invention, higher confidentiality can be achieved for the external terminal identifying information and the authentication information.

According to still another aspect of the present invention, even if the user does not have a portable recording medium, the distribution can be performed. According to still another aspect of the present invention, the distribution can be performed using an document scanner. By using a digital camera for the image reading unit, an image of a photograph can be also distributed. According to still another aspect of the present invention, a multi-functional copy machine can also be used.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image distributing apparatus comprising:
an image reading unit that acquires image data by reading an image;
an image file creating unit that creates a first image file from the image data;
a transmitting unit configured to transmit the first image file to an external terminal over an IP network;
a reduced-size image creating unit that creates a second image file, being smaller in size than the first image file, from the image data;
a link information adding unit that adds identification information that uniquely identifies the external terminal to the second image file to obtain an identification information added image file;
a medium writing unit that writes the image file into a portable recoding medium; and
a controlling unit that causes the medium writing unit to write the identification information added image file into the recording medium if the recording medium is connected to the medium writing unit, while the first image file is transmitted to the external terminal by the transmitting unit.

2. The image distributing apparatus according to claim 1, wherein the link information adding unit adds the identification information as a hyperlink to the second image file.

3. The image distributing apparatus according to claim 1, wherein the link information adding unit adds authentication information, required to access to the first image file, to an image of the second image file.

4. The image distributing apparatus according to claim 3, wherein authentication information is any one or combination of an alphanumerical sequence and a two dimensional symbol.

5. The image distributing apparatus according to claim 1, wherein the link information adding unit adds the identification information as a digital watermark.

6. The image distributing apparatus according to claim 3, wherein the link information adding unit adds one or both of the identification information and the authentication information as a digital watermark.

7. The image distributing apparatus according to claim 1, wherein the controlling unit displays a destination for the first image file and a folder for storing the first image file located at the destination on a display if the recording medium is not connected to the medium writing unit, while the first image file is transmitted to the external terminal with the transmitting unit.

8. The image distributing apparatus according to claim 1, wherein the image reading unit is a document scanner that acquires image data by scanning an original.

9. An image forming apparatus comprising:
an image distributing apparatus including
a document scanner that acquires image data by scanning a document;
an image file creating unit that creates a first image file from the image data;
a transmitting unit configured to transmit the first image file to an external terminal over an IP network;
a reduced-size image creating unit that creates a second image file, being smaller in size than the first image file, from the image data;
a link information adding unit that adds identification information that uniquely identifies the external terminal to the second image file to obtain an identification information added image file;
a medium writing unit that writes the image file into a portable recoding medium; and
a controlling unit that causes the medium writing unit to write the identification information added image file into the recording medium if the recording medium is connected to the medium writing unit, while the first image file is transmitted to the external terminal by the transmitting unit;
a printer configured to print an image onto a printing medium; and
an image data processing unit that converts the image data generated by the document scanner in the image distributing apparatus to printing image data suitable for printing by the printer, and outputs the printing image data to the printer.
